(19) United States
(12) Patent Application Publication
(10) Pub. No.: US 2026/0037788 A1
(43) Pub. Date: Feb. 5, 2026

(54) DIRECTION-SELECTIVE NEUROMORPHIC CIRCUITS

(71) Applicant: National Technology & Engineering Solutions of Sandia, LLC, Albuquerque, NM (US)

(72) Inventor: Suma George Cardwell, Albuquerque, NM (US)

(21) Appl. No.: 18/790,644

(22) Filed: Jul. 31, 2024

(51) Int. Cl. G06N 3/063

(52) U.S. Cl. CPC G06N 3/063

(57) ABSTRACT

A direction-selective neuromorphic circuit is provided comprising a first dendrite comprising first and second compartments and a destination compartment arranged sequentially, wherein the first dendrite is tuned to detect a first pattern. A second dendrite comprises first and second compartments and a destination compartment arranged sequentially, wherein the second dendrite is tuned to detect a second pattern. Input from a first spike generator is input to the first compartment of the first dendrite and the second compartment of the second dendrite. Input from a second spike generator is input to the first compartment of the second dendrite and the second compartment of the first dendrite. Responsive to detecting the first pattern, the destination compartment of the first dendrite spikes and laterally inhibits the second dendrite. Responsive to detecting the second pattern, the destination compartment of the second dendrite spikes and laterally inhibits the first dendrite.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The present disclosure relates generally to artificial neural networks and more specifically to direction-selective circuits with inhibition or winner-takes-all at the end.

### 2. Background

In space systems, real-time detection for transient change is subject to jitter, moving backgrounds, and other real-world challenges. Rapid detection of new/anomalous activity with low latency is also critical. Current approaches like use flexible statistical models for scene background and variability using frame-based cameras. Event cameras have sparse output, only responding to changes in the scene and produce 100× less data in sparse scenes relative to Focal Plane Arrays (FPAs).

Separating and reconstructing the target temporal signature in the presence of scene motion caused by orbit/pointing is an unsolved problem for event sensors. Specific challenges to these areas include: the detection of transient events of interest in the presence of scene motion; accounting for camera motion; and the requirement of low SWaP (Size Weight and Power) and low false alarm rate (FAR) due to the limited communication bandwidth in space systems.

Therefore, it would be desirable to have a method and apparatus that take into account at least some of the issues discussed above, as well as other possible issues.

### SUMMARY

An illustrative embodiment provides a direction-selective neuromorphic circuit comprising a first dendrite comprising first and second compartments and a destination compartment arranged sequentially, wherein the first dendrite is tuned to detect a first pattern. A second dendrite comprises first and second compartments and a destination compartment arranged sequentially, wherein the second dendrite is tuned to detect a second pattern. Input from a first spike generator is input to the first compartment of the first dendrite and the second compartment of the second dendrite. The input from the first spike generator has a first weight. Input from a second spike generator is input to the first compartment of the second dendrite and the second compartment of the first dendrite. The input from the second spike generator has a second weight. A delay is modeled between the compartments of the dendrites. Responsive to detecting the first pattern, the destination compartment of the first dendrite spikes and laterally inhibits the second dendrite. Responsive to detecting the second pattern, the destination compartment of the second dendrite spikes and laterally inhibits the first dendrite.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a passive resistor-capacitor circuit diagram modeling a neuromorphic dendrite in accordance with an illustrative embodiment;

FIG. 2 depicts a passive transistor circuit diagram modeling a neuromorphic dendrite in accordance with an illustrative embodiment;

FIG. 3 depicts a diagram of a direction-selective dendrite circuit in accordance with an illustrative embodiment;

FIG. 4A depicts input spike generator for Pattern 1 and Pattern 2 for the direction-selective dendrite circuit in accordance with an illustrative embodiment;

FIG. 4B depicts input spikes to Compartment 0 of both dendrites of the direction-selective dendrite circuit in accordance with an illustrative embodiment;

FIG. 4C depicts input spikes to Compartment 1 of both dendrites of the direction-selective dendrite circuit in accordance with an illustrative embodiment;

FIG. 4D depicts destination compartment current for both dendrites of the direction-selective dendrite circuit in accordance with an illustrative embodiment;

FIG. 4E depicts destination compartment voltage for both dendrites of the direction-selective dendrite circuit in accordance with an illustrative embodiment;

FIG. 4F depicts destination compartment spikes of Pattern 1 and Pattern 2 dendrites, respectively, of the direction-selective dendrite circuit in accordance with an illustrative embodiment;

FIG. 5 depicts a diagram of a direction-selective dendrite circuit implemented with a non-volatile memory device in accordance with an illustrative embodiment;

FIG. 6 depicts a diagram illustrating hierarchical direction-selective dendrite circuits in accordance with an illustrative embodiment;

FIG. 7 depicts a diagram illustrating the determination of complete features relative to a sensor pixel array in accordance with an illustrative embodiment;

FIG. 8 depicts a diagram illustrating super pixel circuit in accordance with an illustrative embodiment;

FIG. 9A depicts a diagram illustrating a super pixel programed for direction detection in accordance with an illustrative embodiment;

FIG. 9B depicts a diagram illustrating a super pixel programed for pattern detection in accordance with an illustrative embodiment;

FIG. 10 depicts a diagram illustrating a super pixel programed for direction detection based on velocity in accordance with an illustrative embodiment; and

FIG. 11 depicts a diagram illustrating design of delay lines in dendrites according to an illustrative embodiment.

### DETAILED DESCRIPTION

The illustrative embodiments recognize and take into account that real-time detection for transient change is subject to jitter, moving backgrounds, and other real-world challenges. Separating and reconstructing the target temporal signature in the presence of scene motion caused by orbit/pointing is an unsolved problem for event sensors.

The illustrative embodiments also recognize and take into account that dendrites are the computational interconnects of the brain. However, they are often overlooked while modeling neuromorphic architectures and algorithms in favor of point neurons. Biological dendrites have demonstrated a range of nonlinear properties that support a range of computations including direction selectivity, coincidence detection, spatiotemporal filtering, and segregation and amplification of inputs, suggesting a ‘dendritic toolkit’ that offers computational richness that is yet to be effectively exploited in neuromorphic architectures.

The illustrative embodiments provide a method and system for spatiotemporal pattern recognition and direction selectivity using dendrites on, e.g., the Loihi neuromorphic platform. The dendritic circuits comprise inhibition or a winner-take-all at the end, which laterally inhibits other circuits closer to the original in magnitude. These dendritic circuits can be coupled with an event sensor for pattern detection and assembled hierarchically as building blocks for classifying complex spatiotemporal patterns.

A spiking retina camera can be designed using these circuits for a smaller pixel size.

Nonlinear interactions between different conductances on dendritic branches, typically driven by weighted synaptic input, can be used to implement multiple logic operations. There is growing interest in leveraging silicon dendrites as computational interconnects to model multi-compartment neurons. It is hypothesized that dendrites will add to the computational complexity of deep learning algorithms by enabling increased computation and pre-processing in single neurons and additional learning rules.

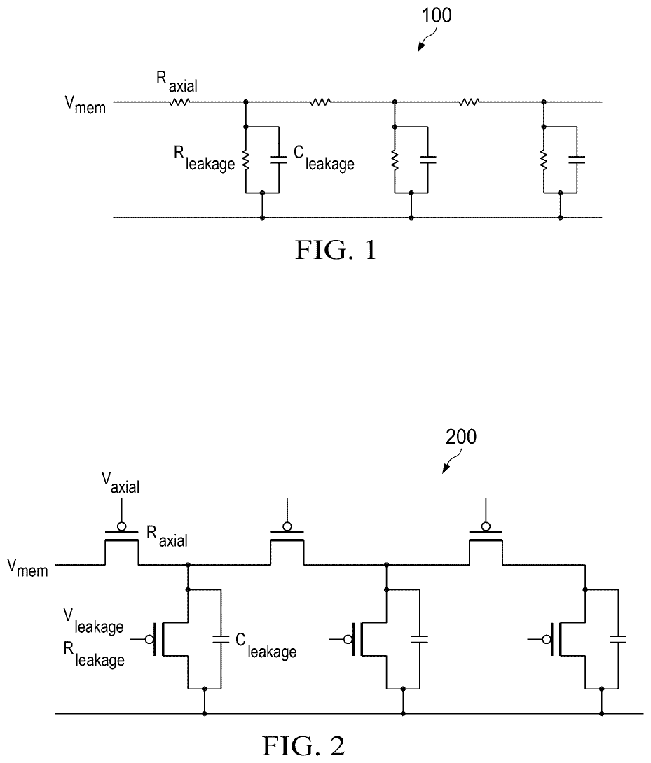

A resistor-capacitor (RC) circuit such as that shown in FIG. 1 captures the ‘passive’ properties of a biological dendrite. In this passive RC circuit 100, Vₘₑₘ is the membrane potential, Rₐₓᵢₐₗ is the axial resistance and R_{leakage}, C_{leakage} are the leakage resistance and capacitance respectively. This RC circuit 100, in turn, can be modeled using CMOS transistors operating in a linear region as shown in FIG. 2. In CMOS circuit 200, transistors used to model a passive cable in silicon where Vₐₓᵢₐₗ is the gate voltage for the axial transistor and Vₗₑₐₖ is the gate voltage for the leakage transistor.

Active components may be included to emulate the complexity of active, time-varying conductances that are present in biological dendrites, for example a silicon model of the NMDA (N-Methyl-D-Aspartate) conductance. There are also several efforts to leverage emerging devices, for example memristors or multi-gate ferroelectric FETs (field effect transistors), to build artificial dendrites. These devices provide low-power solutions, can be integrated with CMOS (Complementary Metal-Oxide Semiconductor), and have the potential to leverage three-dimensional stacking techniques to increase connectivity that will amplify the advantages offered by neuromorphic dendrites.

Direction selectivity and coincidence detection are properties of dendrites that can be exploited to classify spatiotemporal patterns. In particular we were inspired by dendritic computation performing nonlinear spatiotemporal filtering that can be used to develop direction-selective circuits and also for pattern recognition.

We demonstrate a direction-selective circuit built using dendrites on Intel's Loihi 1 chip. The example demonstrated is relevant for event sensor inputs. Event sensors are bio-inspired sensors that asynchronously measure per-pixel brightness changes and encode an output stream of events that encode time, location, and sign of the brightness change. Event cameras encode only motion in a given scene. They have high temporal resolution, high dynamic range, low power consumption, and reduced motion blur. Event cameras are especially useful since they encode only motion in a given scene. The inputs for the experiment model pixel activation in the UP and DOWN direction.

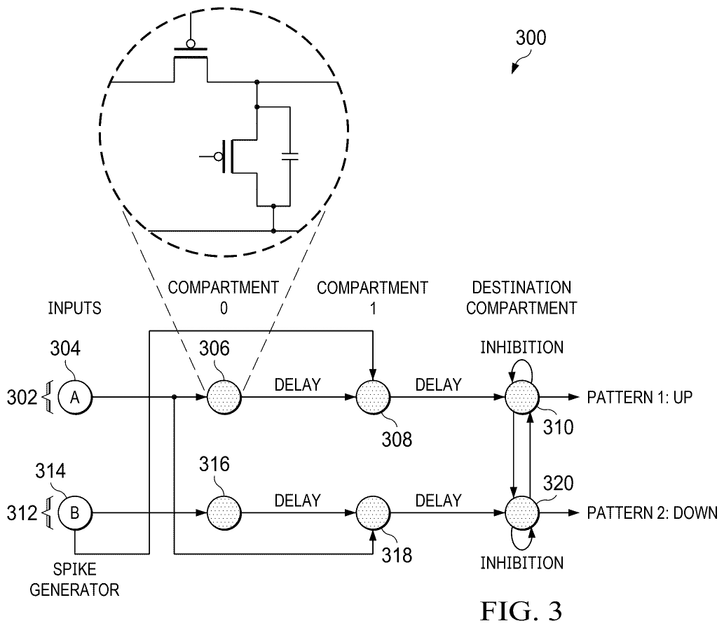

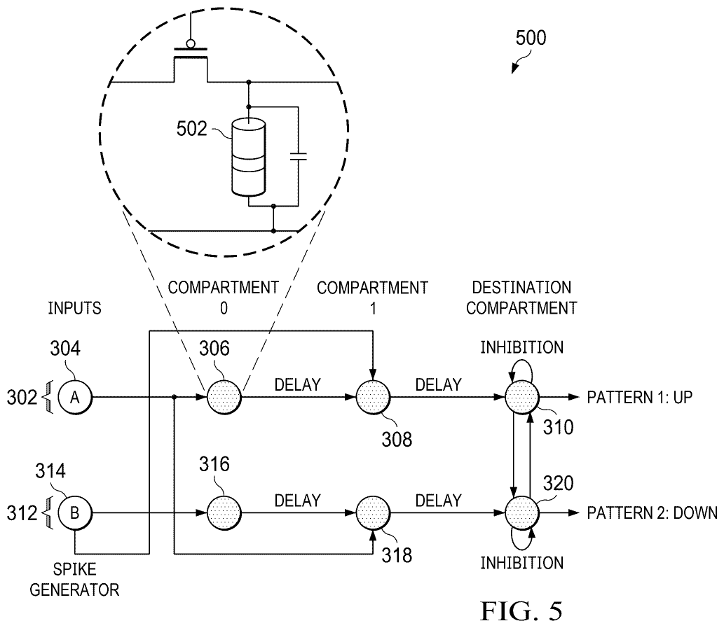

FIG. 3 depicts a diagram of a direction-selective dendrite circuit in accordance with an illustrative embodiment. The direction-selective circuit 300 comprises two dendrites 302, 312. Each dendrite comprises a compartment 0 306, 316, a compartment 1 308, 318, and a destination compartment 310, 320, respectively. As shown in the present example, these dendritic compartments 302, 304, 306, 308, 316, 318 can be implemented with CMOS transistors such as those shown in FIG. 2 or with any non-volatile memory devices such as floating gate transistors, memristors, multi-gate ferroelectric FETs, or magnetic tunnel junctions (MTJs) (see FIG. 5).

The direction-selective circuit 300 as shown in FIG. 3 takes inputs from spike generators 304, 314 from multiple pixels along the Loihi dendrite. Each dendritic compartment adds input from one spike generator as well as the ‘upstream’ compartment in the dendrite. There is a fixed transmission delay of one timestep between each dendritic compartment. We demonstrate our experiment for two patterns for upward and downward motion as seen by an event camera. For simplicity, we model two adjacent-in-space pixel inputs from spike generators 304, 314. Each pixel sends input to compartment 0 of one dendrite and compartment 1 of the other dendrite. We use the Loihi spike generator to simulate the pixel input spikes for the circuit.

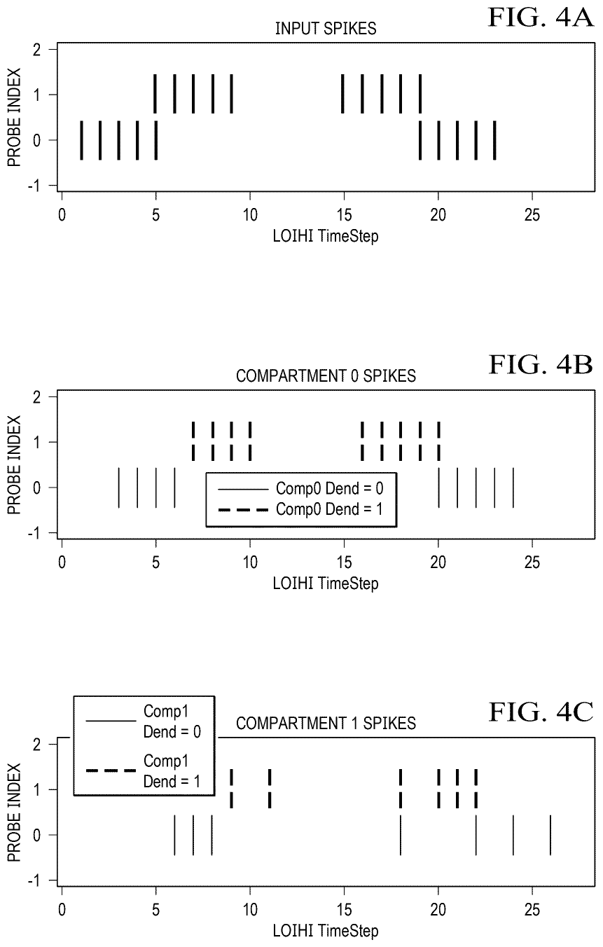

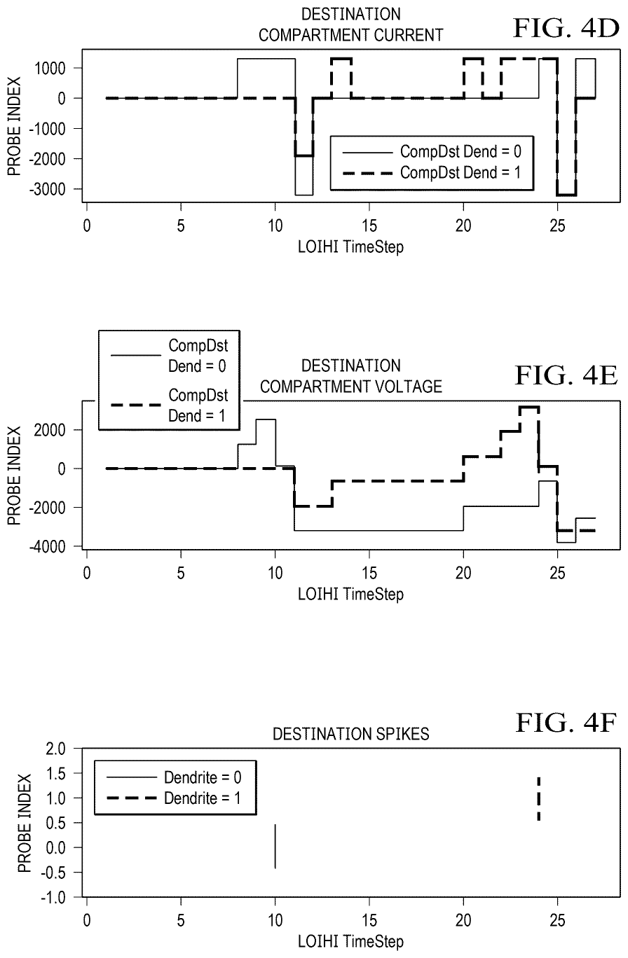

FIGS. 4A-4F depict graphs illustrating direction-selective dendrite circuit 300 output for Pattern 1 (UP) and Pattern 2 (DOWN). The inputs are modeled as spikes generated by an event sensor responding to an LED point source moving in the UP or DOWN direction. FIG. 4A depicts input spike generator patterns for UP (time steps 1 to 9) and DOWN (time steps 15 to 23). FIG. 4B depicts input spikes to Compartment 0 of both dendrites. FIG. 4C depicts input spikes to Compartment 1 of both dendrites. FIG. 4D depicts destination compartment current for both dendrites. FIG. 4E depicts destination compartment voltage for both dendrites. FIG. 4F depicts destination compartment spikes of UP and DOWN dendrites, respectively.

As shown in FIGS. 4A-4F, each dendrite is tuned to detect a certain direction. In the present example, dendrite 302 detects UP, and dendrite 312 detects DOWN. Both compartments 0 and 1 receive inputs driven by both UP and DOWN patterns (see FIGS. 4D and 4E). However, as soon as a dendrite detects a pattern (e.g., the DOWN dendrite 312 detects the DOWN pattern), it laterally inhibits the other dendrite, causing it to reset. This inhibition ensures only the correct destination compartment spikes. The destination compartment also inhibits itself once it spikes. The destination compartment and voltage trends are not exactly mirror images as seen in FIGS. 4D and 4E because the destination compartment voltage is not completely reset to initial conditions after the first pattern is detected.

The direction-selective local dendritic circuit 300 is an example of spatiotemporal processing that can be incorporated into a hierarchical model to detect more complex patterns.

FIG. 5 depicts a diagram of a direction-selective dendrite circuit implemented with a non-volatile memory device in accordance with an illustrative embodiment. As explained above, the compartments in direction-selective circuit 300 can be replaced with any non-volatile memory devices such as floating gate, transistors, memristors, multi-gate ferroelectric FETs, or magnetic tunnel junctions (MTJ). Non-volatile memory devices facilitate densely packing many components into a small area. Such non-volatile memory devices can be mixed and matched with regular (e.g., CMOS) transistors. For example, a CMOS transistor can be used for the axial resistance and a non-volatile memory device for the leaks.

In the example alternate embodiment shown in FIG. 5, direction-selective dendritic circuit 500 replaces the CMOS transistors in the dendritic compartments shown in FIGS. 2 and 3 with MTJ 502.

It should be understood that the neuromorphic dendrites might comprise more than three compartments as shown in the examples above. The number of compartments (stages) present in a dendrite is dependent on the sensor providing input and the pattern to be detected.

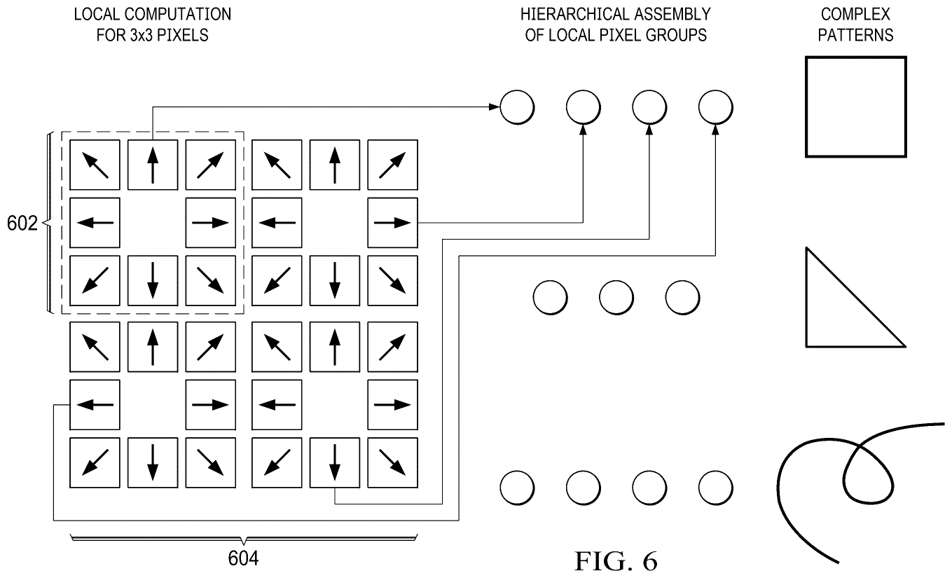

FIG. 6 depicts a diagram illustrating hierarchical direction-selective dendrite circuits in accordance with an illustrative embodiment. As shown in the example in FIG. 6, local direction-selective circuits can be used for pattern detection by hierarchically combining different local direction-selective circuits. The present example uses 3×3 pixel grids 602. However, larger pixel grids can be utilized as well as overlap between pixel grids.

In this example, each 3×3 pixel grid 602 is able to detect six possible directions. Once a dendrite within the 3×3× pixel grid 602 has found its output for its respective direction, it suppresses the other dendrites in the grid to prevent them from spiking. The respective outputs of the other 3×3 pixel grids comprising the larger grid 504 can be combined to construct more complex patterns.

Dendrites provide an inexpensive way to do computation that can be position close to a sensor (near sensor processing) to quickly detect simple patterns, from which complex patterns can be built.

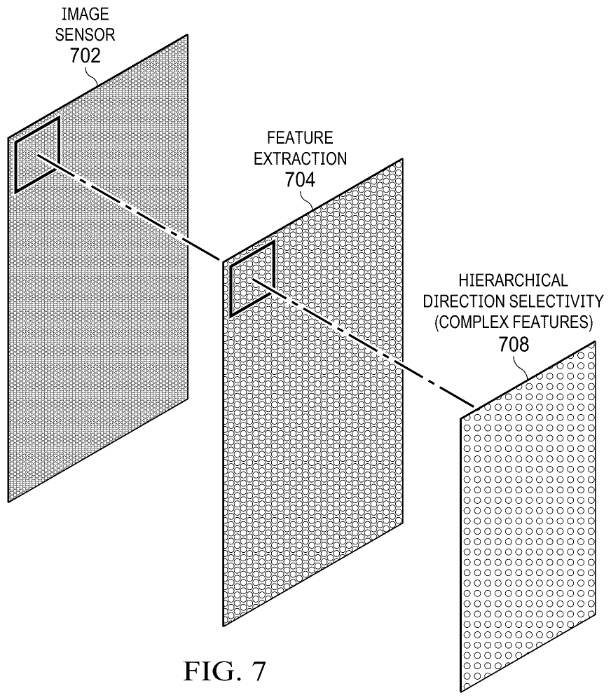

FIG. 7 depicts a diagram illustrating the determination of complete features relative to a sensor pixel array in accordance with an illustrative embodiment. Image sensor 702 comprises N×M pixels, which can be divided into respective groups forming super pixels 704. The groups of super pixels detect respective patterns that can be combined hierarchically into complex features 706 (see FIG. 6).

The complex features 706 can then be fed downstream to a neural network or other type of algorithm for further processing.

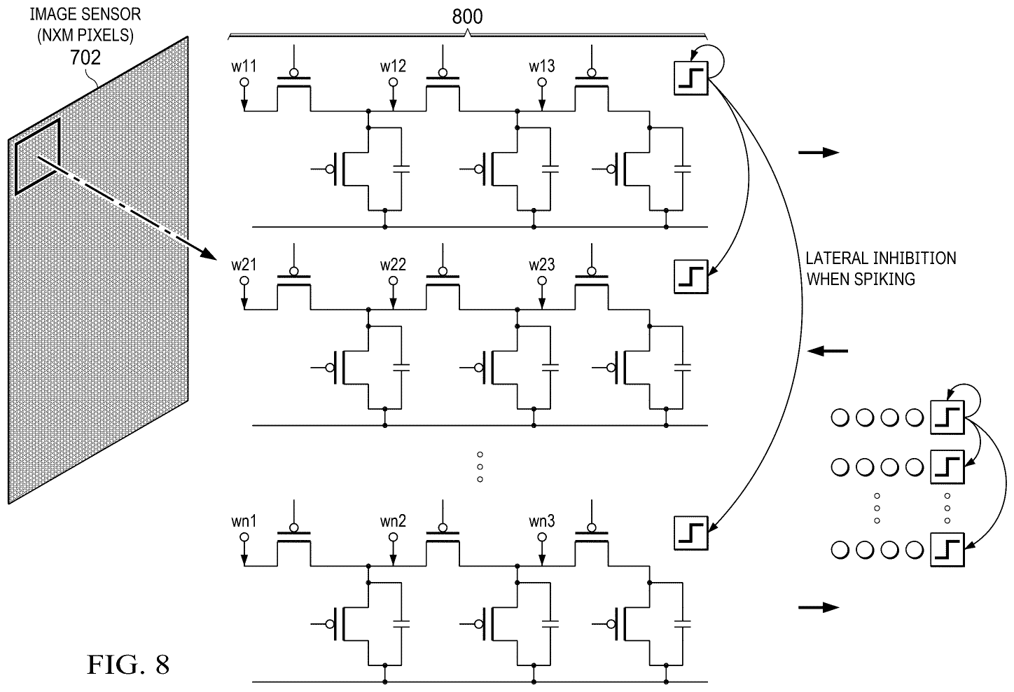

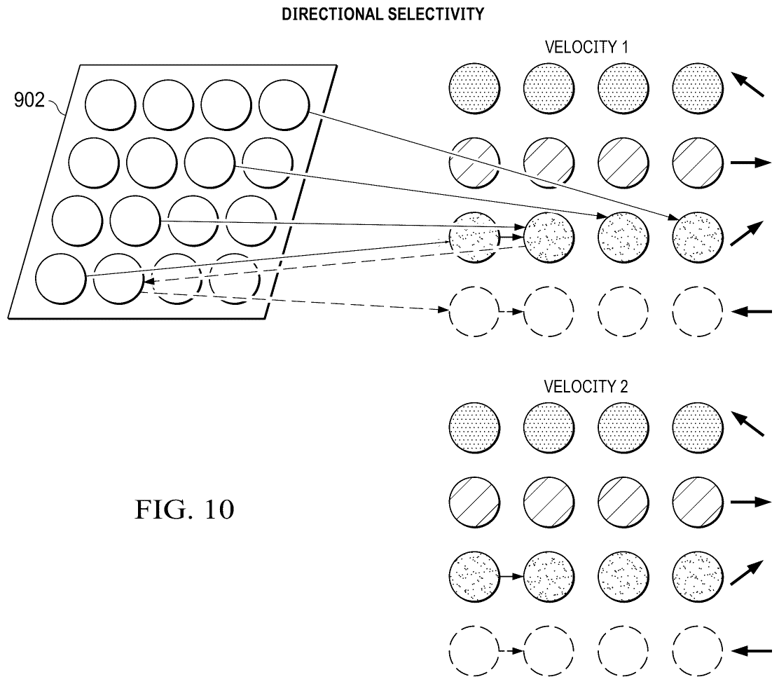

FIG. 8 depicts a diagram illustrating super pixel circuit in accordance with an illustrative embodiment. The pixels in image sensor 702 have respective dendrites 800. Each dendrite aggregates input from different pixels (see FIG. 10). Each input has an associated weight (e.g., w11, w12, etc.).

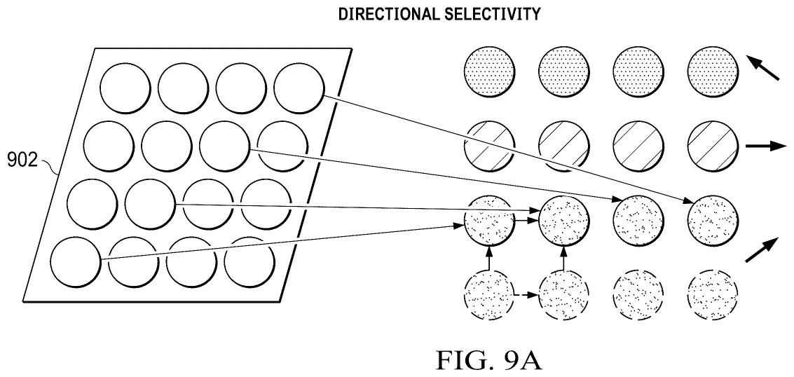

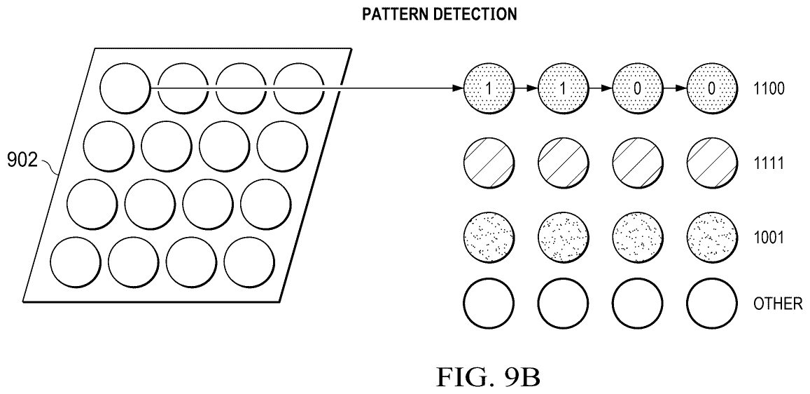

FIG. 9A depicts a diagram illustrating a super pixel programed for direction detection in accordance with an illustrative embodiment. FIG. 9B depicts a diagram illustrating a super pixel programed for pattern detection in accordance with an illustrative embodiment. The same super pixel 902 can be programmed to perform both direction selection and pattern detection. Super pixel 902 operates as a feature extractor before input into a neural network.

FIG. 10 depicts a diagram illustrating a super pixel programed for direction detection based on velocity in accordance with an illustrative embodiment. The pixels selected in super pixel 902 depend on the direction detected (e.g., if there is a diagonal direction the diagonal pixels (designated by the arrows) are selected).

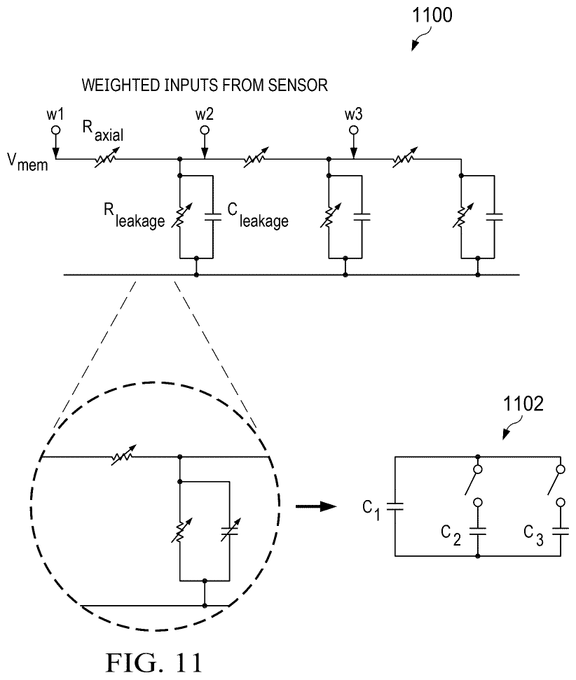

Different delay line (dendrite) dictionaries for different velocities. The signal across the pixels in super pixel 902 might change at a specific speed. For example, in some cases the signal across the pixels might be on the scale of milliseconds and in other cases it might be on a scale of microseconds. Different dendrites can be tuned (via modeled delays) for different velocities such that only those signals are detected. For example, input on the scale of microseconds might be ignored, whereas input on the scale of milliseconds or second is not. Therefore, the same super pixel can have different delay lines of dendrites that select for particular speeds (i.e., Velocity 1, Velocity 2) (see FIG. 11).

FIG. 11 depicts a diagram illustrating design of delay lines in dendrites according to an illustrative embodiment. Every element in dendrite 1100 is variable including conductance and capacitance. Conductance values are programmable and learned to detect features.

Changing the conductance and capacitance changes the time scale (tau) of the dendrite (e.g., to make it millisecond sensitive or microsecond sensitive). Routing capacitance or a capacitance bank 1102 can be used for different velocities.

Inputs from the pixels are weighted (e.g., w1, w2, w3) as they come into the dendrite 1100. The weights might change depending on the pattern in question.

It should be noted that while there is practically no difference in the energy cost of a neuron versus a dendritic compartment on the Loihi platform, if the dendrites are implemented in analog, the circuit footprint is much lower compared to the same circuit constructed from multiple neurons. This quality is advantageous when we want to construct large number of pre-processing circuits that can quickly detect relevant features from an event sensor.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A direction-selective neuromorphic circuit, comprising:
a first dendrite comprising first and second compartments and a destination compartment arranged sequentially, wherein the first dendrite is tuned to detect a first pattern; and
a second dendrite comprising first and second compartments and a destination compartment arranged sequentially, wherein the second dendrite is tuned to detect a second pattern;
wherein there is a delay modeled between the compartments of the dendrites;
wherein input from a first spike generator is input to the first compartment of the first dendrite and the second compartment of the second dendrite, and wherein the input from the first spike generator has a first weight;
wherein input from a second spike generator is input to the first compartment of the second dendrite and the second compartment of the first dendrite, and wherein the input from the second spike generator has a second weight;
wherein, responsive to detecting the first pattern, the destination compartment of the first dendrite spikes and laterally inhibits the second dendrite; and
wherein, responsive to detecting the second pattern, the destination compartment of the second dendrite spikes and laterally inhibits the first dendrite.

2. The direction-selective neuromorphic circuit of claim 1, wherein the first and second destination compartments inhibit themselves after spiking.

3. The direction-selective neuromorphic circuit of claim 1, wherein each dendritic compartment adds input from one of the spike generators as well as upstream compartment in the dendrite.

4. The direction-selective neuromorphic circuit of claim 1, further comprising a fixed transmission delay of one timestep between each dendritic compartment.

5. The direction-selective neuromorphic circuit of claim 1, wherein at least one of the dendritic compartments comprise passive resistor-capacitor circuits.

6. The direction-selective neuromorphic circuit of claim 5, wherein the resistor-capacitor circuits are modeled using CMOS transistors.

7. The direction-selective neuromorphic circuit of claim 1, wherein at least one of the dendritic compartments comprise non-volatile memory devices.

8. The direction-selective neuromorphic circuit of claim 7, wherein the non-volatile memory devices comprise at least one of:
floating gate transistors;
memristors;
multi-gate ferroelectric FETs; or
magnetic tunnel junctions.

9. The direction-selective neuromorphic circuit of claim 1, wherein the direction-selective neuromorphic circuit is one of many direction-selective neuromorphic circuits arranged hierarchically.

10. A direction-selective neuromorphic circuit, comprising:
first and second dendrites, wherein the first and second dendrites are tuned to detect different respective patterns, and wherein each dendrite comprises:
a spike generator;
a first compartment;
a second compartment;
destination compartment; and
wherein there is a delay modeled between the compartments of the first and second dendrites;
wherein input from a spike generator in one of the dendrites is fed into the first compartment of that dendrite and the second compartment of the other dendrite, wherein the spike generator has weighted synaptic inputs; and
wherein, responsive to detecting one of the respective patterns, the destination compartment of the detecting dendrite spikes and laterally inhibits the other dendrite.

11. The direction-selective neuromorphic circuit of claim 10, wherein the destination compartment inhibits itself after spiking.

12. The direction-selective neuromorphic circuit of claim 10, wherein each dendritic compartment adds input from the spike generator as well as upstream compartment in the dendrite.

13. The direction-selective neuromorphic circuit of claim 10, further comprising a fixed transmission delay of one timestep between each dendritic compartment.

14. The direction-selective neuromorphic circuit of claim 10, wherein at least one of the dendritic compartments comprise passive resistor-capacitor circuits.

15. The direction-selective neuromorphic circuit of claim 14, wherein the resistor-capacitor circuits are modeled using CMOS transistors operating in a linear region.

16. The direction-selective neuromorphic circuit of claim 10, wherein at least one of the dendritic compartments comprises non-volatile memory devices.

17. The direction-selective neuromorphic circuit of claim 16, wherein the non-volatile memory devices comprise at least one of:
floating gate transistors;
memristors;
multi-gate ferroelectric FETs; or
magnetic tunnel junctions.

18. The direction-selective neuromorphic circuit of claim 10, wherein the direction-selective neuromorphic circuit is one of many direction-selective neuromorphic circuits arranged hierarchically.

19. A direction-selective neuromorphic circuit, comprising:
a number of dendrites, wherein the dendrites are tuned to detect different respective patterns, and wherein each n dendrite comprises:
a spike generator;
a first compartment;
a second compartment;
destination compartment; and
wherein there is a delay modeled between the compartments of the dendrites;
wherein weighted input from a spike generator in one of the dendrites is fed into the first compartment of that dendrite and the second compartment of the other dendrites, wherein each dendritic compartment adds input from the spike generator as well as upstream compartment in the dendrite, and wherein there is a fixed transmission delay of one timestep between each dendritic compartment; and
wherein, responsive to detecting one of the respective patterns, the destination compartment of the detecting dendrite spikes, laterally inhibits the other dendrites, and inhibits itself after spiking.

20. The direction-selective neuromorphic circuit of claim 19, wherein the dendritic compartments comprise at least one of:
CMOS transistors; or
non-volatile memory devices.
